(19) United States
(12) Patent Application Publication
(10) Pub. No.: US 2017/0270427 A1
(43) Pub. Date: Sep. 21, 2017

(54) MULTI-VIEW MACHINE LEARNING

(71) Applicant: Microsoft Technology Licensing, LLC, Redmond, WA (US)

(72) Inventors: Hucheng Zhou, Beijing (CN); Bokai Cao, Beijing (CN)

(73) Assignee: Microsoft Technology Licensing, LLC

(21) Appl. No.: 15/073,520

(22) Filed: Mar. 17, 2016

(51) Int. Cl. G06N 99/00

(52) U.S. Cl. CPC G06N 99/005

(57) ABSTRACT

In implementations of the subject matter described herein, a machine learning scheme is proposed. Features of historical inputs from a user as well as corresponding outputs presented to the user in response to the historical inputs are obtained, where the features are previously determined based on contexts of the historical inputs which indicate information related to the user. The features of the historical inputs are assigned into a plurality of groups. An association is determined on the basis of the plurality of groups of features. Specifically, an association indicating inter-group correlations of features from different ones of the groups is determined according to the obtained outputs. Therefore, in determining the association, intra-group correlations such as correlations of features within a group are excluded. In this way, the time and computation complexity for the association determination will be effectively reduced.

### BACKGROUND

Machine learning techniques are used to build a model or association from a set of historical data to make predictions about future events. A machine learning process takes advantage of various features present in the historical data and trains a model represented by an association among the features. The resulting model may be used in a wide variety of use cases for the purpose of classification, regression, or the like. Some examples of those use cases include advertisement (or “ad”) targeting, movie rating, recommendations of services or products, and the like. As a detailed example, the model used for ad targeting may be constructed as a classification model to predict whether display of an ad to a specific user when he or she searches for a query will lead to a click.

In order to achieve an effective model to present more precise output results, a large amount of historical data and/or various features for each data record may be considered, which will increase the time and computation complexity in the model training. On the other hand, the way for constructing and estimating the association among the features is also important for an effective model.

### SUMMARY

In accordance with implementations of the subject matter described herein, a machine learning scheme is proposed. Features of historical inputs from a user as well as corresponding outputs presented to the user in response to the historical inputs are obtained, where the features are previously determined based on contexts of the historical inputs which indicate information related to the user. As used herein, the term “feature” refers to information used to characterize an aspect(s) of an input. The features of the historical inputs are assigned into a plurality of groups. An association is determined on the basis of the plurality of groups of features. Specifically, an association indicating inter-group correlations of features from different ones of the groups is determined according to the obtained outputs. Therefore, in determining the association, intra-group correlations such as correlations of features within a group are excluded. In this way, the time and computation complexity for the association determination will be effectively reduced.

The determined association may be used to make predication for a further input. In accordance with implementations of the subject matter described herein, a scheme for applying an association determined from the machine learning is proposed. In response to an input from a user, features of the input are obtained based on a context of the input and then assigned into a plurality of groups. The assignment of features into the groups may be similar to what is done in the association determination. An output is generated based on the groups of features according to the determined association.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 illustrates a block diagram of an environment where implementations of the subject matter described herein can be implemented;

FIG. 2 illustrates an example diagram of an association of a machine learning model in accordance with one implementation of the subject matter described herein;

FIG. 3 illustrates a flowchart of a method of machine learning in accordance with one implementation of the subject matter described herein;

FIG. 4 illustrates a flowchart of a method of applying a machine learning model in accordance with another implementation of the subject matter described herein; and

FIG. 5 illustrates a block diagram of an example computing system/server in which one or more implementations of the subject matter described herein may be implemented.

### DETAILED DESCRIPTION

The subject matter described herein will now be discussed with reference to several example implementations. It should be understood these implementations are discussed only for the purpose of enabling those skilled persons in the art to better understand and thus implement the subject matter described herein, rather than suggesting any limitations on the scope of the subject matter.

As used herein, the term “includes” and its variants are to be read as open terms that mean “includes, but is not limited to.” The term “or” is to be read as “and/or” unless the context clearly indicates otherwise. The term “based on” is to be read as “based at least in part on.” The term “one implementation” and “an implementation” are to be read as “at least one implementation.” The term “another implementation” is to be read as “at least one other implementation.” The terms “first,” “second,” and the like may refer to different or same objects. Other definitions, explicit and implicit, may be included below. A definition of a term is consistent throughout the description unless the context clearly indicates otherwise.

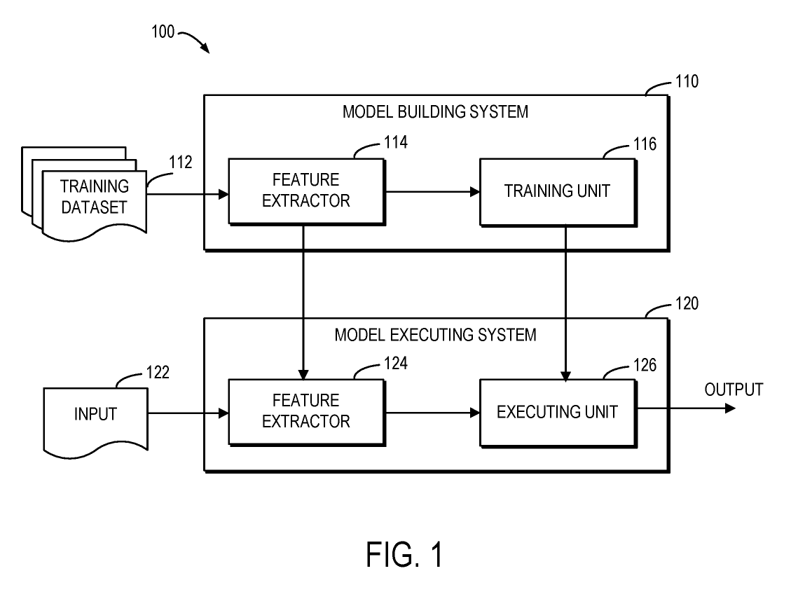

FIG. 1 shows a block diagram of an environment 100 where implementations of the subject matter described herein can be implemented. It is to be understood that the structure and functionality of the environment 100 are described only for the purpose of illustration without suggesting any limitations as to the scope of the subject matter described herein. The subject matter described herein can be embodied with a different structure and/or functionality.

The environment 100 includes a model building system 110 and a model executing system 120. The model building system 110 is configured to build a model from a training dataset 112 for a certain kind of use case. The dataset 112 may include files of any machine readable formats. These files may be obtained from any suitable sources, including, but not limited to, databases, or the Internet. The files in the dataset 112 may include historical inputs from one or more users and their corresponding outputs presented to the users in response to the inputs. By way of example, for click-through-rate prediction in ad targeting, the files in the dataset 112 may include historical input queries of users and corresponding ads presented to the users collected from ad impression logs of search engines. As another example, for movie rating, the files in the dataset 112 may include historical movies watched by users and corresponding scores rated by the users.

A feature extractor 114 included in the model building system 110 may obtain features from the dataset 112 based on contexts of the historical inputs. A context of an input indicates information related to a corresponding user, including not only a profile of the user himself, but also information related to the input event the user triggered, information on the output presented to the user in response to the input, and/or any other information that may have influence on the output of this input event. Considering the ad targeting as an example, a context of an input query may include information on the user, information on the query input by the user, information on the ad presented to the user, and the like.

In some implementations, the feature extractor 114 may extract features describing one or more aspects of the contexts of the historical inputs. For example, for a context of an input query event, features indicating one or more of the following may be extracted: the user identifier, the age of the user, the gender of the user, query words, the address of the ad presented in response to the query, the location of the ad, the matched type of the ad, and so on. In some implementations, the features may be quantified to a range of values. For example, the age of the user may be assigned with a value in a range with different values corresponding to different ages. In one implementation, the values of the features may be normalized to a range from 0 to 1. It would be appreciated that the features may be represented as values in any other ranges.

A training unit 116 included in the model building system 110 is configured to learn a model with an association among the features of the historical inputs based on the outputs. The association may represent a function between the historical inputs and the corresponding outputs. Hereinafter, the terms “model” and “function” are used interchangeably to indicate the machine learning result.

As an example, for a given training dataset Δ with n historical inputs and n corresponding outputs, it may be represented as Δ={(xᵢ,yᵢ)|i=1, . . . , n}, where xᵢ∈ [symbol] represents the i-th historical input and is described by d extracted features, and yᵢ represents the i-th output presented to the user in response to the i-th input. In the example of ad targeting, yᵢ∈{−1,1}, where yᵢ=1 represents that the i-th presented ad is clicked by the user and yᵢ=−1 represents that the i-th presented ad is not clicked by the user. The training unit 116 may learn a model or function from the training dataset Δ to predict whether an ad presented to a specific user in response to an input query of the user will lead to a click or not. The function may give an output of either −1 or 1.

Although the feature extractor 114 is shown as being included in the system 110 in the implementations of FIG. 1, in some other implementations, the feature extractor 114 may be separated from the system 110. The raw training dataset may be processed by a remote feature extractor 114. The dataset 112 input to the model building system 110, for example, to the training unit 116, may include the features of the historical inputs extracted by the extractor 114 and corresponding outputs presented in response to the historical inputs.

In some implementations, the trained model from the model building system 110 may be provided to the model executing system 120 for applying on one or more new inputs. Specifically, a feature extractor 124 receives an input 112 and extracts features based on a context of the input 112. The feature extractor 124 may also receive from the feature extractor 114 an indication of the types of features that should be extracted from the input 112. The features extracted in the model executing system 120 may be of the same types as those used to build the model in the system 110. The features may be provided to an executing unit 126 as inputs to the trained model and an output may be produced according to the association of the model. For example, the executing unit 126 may decide whether an ad should be presented to the user of the input 112 by use of the trained model. In some implementations, the feature extractor 124 may also be separated from the model executing system 120.

The general concept of the machine learning environment 100 has been described above with reference to FIG. 1. In order to train an effective machine learning model, a large amount of historical data and/or various features for each data record (for example, more than one hundred thousand features) may be considered for the model building process. This is possible with rapidly growing amount of data available on the Internet or in various databases. However, the growing of historical data and the number of features to be analyzed will result in the increasing of time and computation resources used for the machine learning.

In conventional modeling approaches, a simple method is to model the association as a linear function and thus the association of the function to be estimated includes only the weights for the respective features (and a bias value in some examples). An example of this method is support vector machine (SVM) with a linear kernel. Although it might be easy to determine the weights even the historical data and the number of features are increased, this model is not practical since many actual applications may not follow such a linear association.

Some other modeling methods take correlations of the features into account. For example, a support tensor machine (STM) based method explores correlations of all the features only. A factorization machine (FM) based method combines weights for the features and a correlation of every two of the features. The introduced correlations allow a better approximation to the actual association underlying the features of the input events and the corresponding outputs. The problem with those modeling methods is that they can only efficiently handle small quantities of training data. They also struggle to deal with large quantities of features, such as more than one hundred thousand features.

On the other hand, due to the complexity of correlation computation, the correlations estimated in the models are limited, which makes those models not effective for various use cases. For example, only correlations in the highest order are determined in the STM based method and the second-order correlation of every two of the features is analyzed in some other methods. Other correlations, such as the correlation of every three of the features, the correlation of every four of the features, or the correlation of any other larger number of features, are not explored in the model building. It is observed that integrating correlations in different orders into a model will help to improve the accuracy of the model in various use cases.

In accordance with implementations of the subject matter described herein, a machine learning scheme is proposed. Features of historical inputs and corresponding outputs presented to the user in response to the historical inputs are obtained. The historical inputs and the corresponding outputs herein may be collectively referred to as a training dataset used to train a model. The obtained features, for example, the features of a respective historical input, are assigned into a plurality of groups. Then an association of the model is determined on the basis of the plurality of groups of features. Specifically, an association indicating inter-group correlations of features from different ones of the groups is determined according to the outputs.

Therefore, in the machine learning scheme of the subject matter, intra-group correlations such as correlations of features within a same group are excluded from the association, which will effectively reduce the time and computation complexity. Due to the reduction in time and computation complexity, the machine learning scheme of the subject matter is suitable for determining an association of a machine learning model from a great amount of historical data (inputs and corresponding outputs) and a large number of features for each of the historical inputs. This will help to improve the accuracy of the association.

As an example, for a given training dataset Δ={(xᵢ,yᵢ)|i=1, . . . , n} with n historical inputs each having d features and n corresponding outputs, d features of a historical input xᵢ may be divided into m groups, where m is an integer greater than one. The features of the historical input xᵢ in the training dataset Δ may be represented as xᵢ^{T}=(xᵢ⁽¹⁾^{^{T}}, . . . , xᵢ^{(m)}^{^{T}}), where the superscript T represents an operation of transposition, xᵢ^{(p)}∈ [symbol] represents the p-th group of the input xᵢ with Iₚ denoting a dimension of the p-th group xᵢ^{(p)}, and p is from 1 to m. It can be see that the total number d of features for an input is equal to Σₚ₌₁^{m}Iₚ and thus the dimension of xᵢ is [symbol] . The p-th group xᵢ^{(p)} may include Iₚ features xᵢ_{ₚ}^{(p)} where iₚ is from 1 to Iₚ. In the determination of the association, inter-group correlations of the features from the m groups, xᵢ⁽¹⁾, . . . , xᵢ^{(m)}, may be determined, while intra-group correlations of the features within each of the m groups, xᵢ⁽¹⁾, . . . , xᵢ^{(m)} may not be needed.

In some implementations, a group may be regarded as a view of a historical input and may be assigned with one or more of the features representing the context of the input. As used herein, a view is referred to as a logically meaningful aspect of an input and may be related to one of the entities involved in the input event. For example, for an input query in the ad targeting, there may be three aspects involving three entities, the user, the query, and the ad. Generally, features related to the same view may have small or even negligible correlations and thus can be assigned into one group. In some implementations, the extracted features may be automatically divided to different groups based on the segmentations of the views. Alternatively, or in addition, the user may define how many groups are involved and which features are divided into which groups. It would be appreciated that in some other implementations, the features can be randomly assigned into a predetermined number of groups.

For the example of ad targeting, features related to information on a user, for example, the user identifier, the age of the user, and the gender of the user, may have limited correlations and thus may be assigned into a group related to the user view. Similarly, information on the query of the user such as query words may have limited correlations and thus may assigned into a group related to the query view, and information on the ad presented to the user, for example, the address of the ad presented in response to the query, the location of the ad, and the matched type of the ad, may be assigned into a group related to the ad view. Therefore, features of the i-th input query xᵢ may be represented as xᵢ^{T}=(xᵢ⁽¹⁾^{^{T}},xᵢ⁽²⁾^{^{T}},xᵢ⁽³⁾^{^{T}}), where xᵢ⁽¹⁾ includes features related to the user view, xᵢ⁽²⁾ includes features related to the query view, and xᵢ⁽³⁾ includes features related to the ad view.

The features may be assigned into the groups without overlapping in some implementations. Alternatively, or in addition, if correlations of two or more of the features in one view are important for the model, for example, if these features are correlated with each other in a high level, each of these features may be assigned into two or more of the groups such that their correlations may be considered by determining the inter-group correlations. These implementations may also be applicable for the cases where it not desirable to analyze the correlations of all the features. Specifically, in some cases, all the features may be repeated in each of the groups.

The assignment of features into the groups and the inter-group correlations are discussed in the above. In some implementations, the features may be, for example, obtained and assigned in the groups by the feature extractor 114 in FIG. 1 and the association may be executed by the training unit 116 in FIG. 1 based on the groups of features from the feature extractor 114. The outputs corresponding to the historical inputs may also be provided for the training unit 116 to learn the association.

As discussed above, the time and computation complexity of the association determination can be reduced since only inter-group correlations of features are calculated. In some implementations, it is possible to determine correlation of features in different orders to obtain a more accurate association for the target machine learning model without significantly increasing the complexity. As used herein, an inter-group correlation of features in a different order refers to an inter-group correlation of a different number of features from the different number of groups. For example, an inter-group correlation of two features from any two of the groups may be defined as an inter-group correlation in a second order while an inter-group correlation of three features from any three of the groups may be determined as an inter-group correlation in a third order.

In some implementations, inter-group correlations in at least two orders may be determined for the association of the machine learning model. In these implementations, correlations in different orders will help to explore all the possible relationship between the features of historical inputs and the corresponding outputs more accurately and thus obtain a more effective model. In one implementation, inter-group correlations in all the possible orders may be determined. The number of all the orders may be depending on the number of the groups. For example, if the features are assigned into m groups, inter-group correlations from the second order to the highest m-th order may be obtained.

In some other implementations, in addition to the factors of the inter-group correlations, the association of the machine learning model may also indicate a factor(s) related to weights for the features of the historical inputs and/or a bias value for the model. A weight may indicate a contribution of the respective feature of a historical input to the corresponding output. The bias value for the model may be a scalar value to be estimated.

Factors such as the weights for the features, the bias value for the model, and/or inter-group correlations indicated by the association of the model are collectively referred to as model parameters. For the convenience of the description, the bias value may be regarded as a zero-order model parameter because it is not related to any feature, and a weight for a respective feature may be regarded as a first-order model parameter because it is related to one feature. Similarly, an inter-group correlation in a second order may be regarded as a second-order model parameter and an inter-group correlation in a higher order may also be regarded as a higher-order model parameter. In the implementations where inter-group correlations in all possible orders as well as the weights and the bias value are determined, the association of the model may indicate model parameters in full orders (from the zero order to the highest order), which can further improve the accuracy of the model.

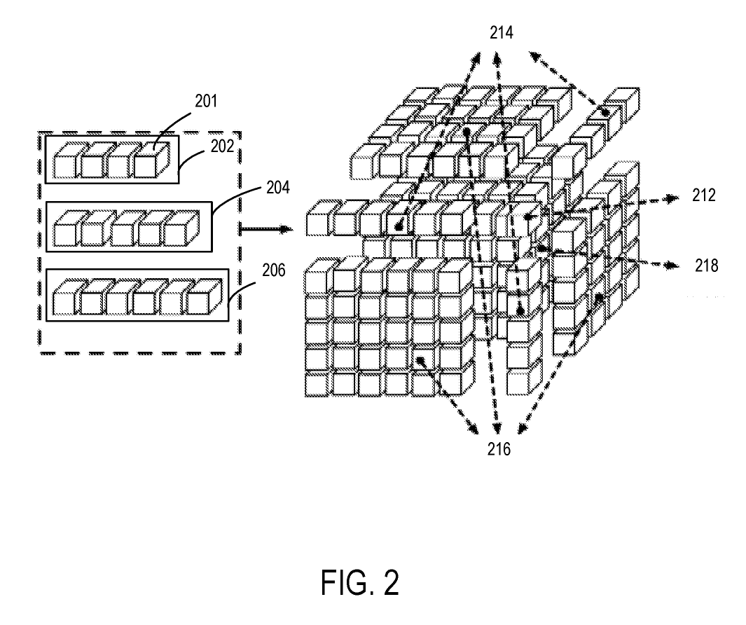

It can be seen that the model parameters in different orders may be represented in different dimensional subspaces. For example, the bias value in the zero order may be a scalar value, the weights for the features in the first order may be represented in a one-dimensional subspace, the second-order inter-group correlations may be represented in a two-dimensional subspace, and the higher-order inter-group correlations may be represented in a higher-dimensional subspace. FIG. 2 shows a schematic diagram of subspaces of model parameters in the example where the features are grouped in three views. As shown in FIG. 2, fifteen features 201 of a historical input are divided into three groups 202, 204, and 206 related to three views. In the shown example, the group 202 includes four features 201, the group 204 includes five features 201, and the group 206 includes six features 201. The bias value for the model, the weights for the features, the inter-group correlations in the second order, and the inter-group correlations in the third order are represented in subspaces 212, 214, 216, and 218, respectively. All the subspaces 212, 214, 216, and 218 form a space of the model parameters.

In one implementation, the association such as the model parameters in full orders including the bias value, the weights for the features, and the inter-group correlations of the features may be used to construct the machine learning model for a use case related to the historical inputs. Since the features are assigned into the groups related to multiple views, the model based on this kind of feature assignment may be referred to as a multi-view machine learning model.

In some examples, depending on the association, the multi-view machine learning model (which is also represented as a function) may be determined as a combination of the bias value, a sum of the weights and the respective features, a sum of the second-order inter-group correlations of the respective pairs of features, and/or a sum of other inter-group correlations indicated by the association and the corresponding subset of features. For example, the multi-view machine learning model may be represented as follows:

$$\hat{y} = {{β}_{0}}_{a bias} + \underbrace{{\sum }_{p = 1}^{∞} {\sum }_{{i}_{p} = 1}^{{I}_{p}} {β}_{{i}_{p}}^{( p )} {x}_{{i}_{p }}^{( p )}}_{using first \text{-} order weights} + \underbrace{{\sum }_{{i}_{1} = 1}^{{I}_{1}} {\sum }_{{i}_{2} = 1}^{{I}_{2}} {β}_{{i}_{1} , {i}_{2 }}^{( 1 , 2 )} {x}_{{i}_{1 }}^{( 1 )} {x}_{{i}_{2}}^{( 2 )} + … + {\sum }_{{i}_{m - 1} = 1}^{{I}_{m - 2}} {\sum }_{{i}_{n} = 1}^{{I}_{n}} {β}_{{i}_{n - 1} , {i}_{n}}^{( m - 1 , m )} {x}_{{i}_{n - 1}}^{( m - 1 )} {x}_{{i}_{n}}^{( m )}}_{using second \text{-} order inter \text{-} group correlations} + … + \underbrace{{\sum }_{{i}_{1} = 1}^{{I}_{1}} … {\sum }_{{i}_{n} = 1}^{{I}_{n}} {β}_{{i}_{1} , … , {i}_{n}} ( {\prod }_{p = 1}^{m} {x}_{{i}_{p }}^{p} )}_{using nth \text{-} order inter \text{-} group correlations} \qquad ( 1 )$$

where ŷ represents the resulting function used to predict outputs for further input events; β₀, represents the bias value; βᵢ_{ₚ}^{(p)} represents a weight for the feature xᵢ_{ₚ}^{(p)}; βᵢ_{ₚ}_{,i}_{_{q}}^{(p,q)} represents a second-order inter-group correlation of features xᵢ_{ₚ}^{(p)} and xᵢ_{_{q}}^{(q)} from groups iₚ and i_{q} with p∈{1, . . . , Iₚ}, q∈{1, . . . , Iₚ}, and p≠q; and βᵢ_{₁}_{, . . . , i}_{ₘ} represents an inter-group correlation in the highest m-th order. An inter-group correlation in an order higher the second order and lower than the m-th order may be similarly represented.

It would be appreciated that although the model is constructed by the model parameters in full orders in Equation (1), in some other implementations, model parameters in some of the orders may be omitted from the model. For example, the weights for the features or the bias value for the model may not be used. In another example, some inter-group correlations may not be considered, such as the second-order inter-group correlations or the highest-order inter-group correlations.

To obtain the model for use, it is required to learn the model parameters (the association of the model) based on the training dataset. In some implementations, with the structure of the model determined, a variety of training methods, no matter currently known or developed in the future, may be utilized to learn the model parameters. Such training methods may include, but are not limited to, alternating least square (ALS), stochastic gradient descent (SGD), limited-memory BFGS (Broyden, Fletcher, Goldfarb, and Shanno), and the like. The model training may be an iteration process and may be implemented in distributed computing devices. For example, the training unit 116 in the model building system 110 may include a plurality of computing device to train the model.

In some implementations, before training the model, the function may be further reconstructed by using a loss function to restrain the output of the model, and the loss function may be selected depending on the actual use case. For example, for the ad targeting, a logit loss function with the output constrained to a range from −1 to 1 may be used. In other use cases, a regression loss function, a hinge loss function, or any other loss function may be used. It would be appreciated that with the structure of the model or the function determined, such as the structure as shown in Equation (1), those skilled in the art can readily envisage the approaches to obtain the model parameters based on the training dataset according to actual requirements.

In order to facilitate determining the association, in some implementations, dimensions of some or all of the model parameters may be extended to the same level. For example, the model parameters in orders lower than the highest m-th order may all be extended to the subspace of the inter-group correlations in the highest order and thus all the model parameters are represented in the same m-dimensional subspace. In some other examples, the model parameters in two or more orders may be extended to the same subspace related to the highest order among these orders, while model parameters in other orders may not be extended or may be extended to other subspaces.

The extension of the model parameters may be implemented by adding one or more “dummy” features into the groups. As used herein, a dummy feature refers to a meaningless feature that will not introduce any impact on interpreting the input associated with the group(s) where it is present. In some implementations, the dummy features may have a constant value. Specifically, in the cases where all the features are quantified into a range from 0 to 1, a dummy feature with a value of 1 may be added into each of the m groups. Therefore, for the p-th group of features xᵢ^{(p)}∈ [symbol] , it may be modified to be z^{(p)}^{^{T}}=(x^{(p)}^{^{T}},1)∈ [symbol] where p=1, . . . , m.

To extend the dimensions of the model parameters, the dummy features in the groups may be used to compensate the dimension differences of the subspaces of the model parameters in different orders. In the implementations where the model parameters are extended to the subspace of correlations in the highest m-th order, based on the added dummy features, the bias value β₀ may be represented as an “inter-group correlation” of dummy features in all the m groups and thus extended to the m-dimensional subspace, and a weight βᵢ_{ₚ}^{(p)} for a feature xᵢ_{ₚ}^{(p)} in the p-th group may be represented as an “inter-group correlation” of the feature xᵢ_{ₚ}^{(p)} and dummy features from other m−1 groups and thus extended to the m-dimensional subspace. Similarly, a second-order correlation βᵢ_{ₚ}_{,i}_{_{q}}^{(p,q)} of features xᵢ_{ₚ}^{(p)} and xᵢ_{_{q}}^{(p)} may be represented as a m-th order correlation of features xᵢ_{ₚ}^{(p)} and xᵢ_{_{q}}^{(p)} as well as dummy features in other m−2 groups, and inter-group correlations in orders lower than the m-th order may be likewise extended. As in the highest order, the m-th order correlations may not be extended.

With the model parameters extended to the same m-dimensional subspace, Equation (1) may be rewritten as follows:

$$\hat{y} = {\sum }_{{i}_{1} = 1}^{{I}_{1} + 1} … {\sum }_{{i}_{m} = 1}^{{I}_{m} + 1} {w}_{{i}_{1} , … , {i}_{m}} ( {\prod }_{p = 1}^{m} {z}_{{i}_{p}}^{( p )} ) \qquad ( 2 )$$

where wᵢ_{₁}_{, . . . , i}_{ₘ} represent a model parameter in the m-th dimensional subspace, which may also be regarded as the m-the inter-group correlation. Suppose that an index of the dummy feature in the p-th group is iₚ=Iₚ+1. w_{I}_{₁}_{+1, . . . , I}_{ₘ}₊₁ in Equation (2) is equal to the bias value β₀ in Equation (1); wᵢ_{₁}_{, . . . , i}_{ₘ} with only iₚ≦Iₚ, i_{q}=I_{q}+1, and q≠P is equal to a weight for a feature βᵢ_{ₚ}^{(p)}; wᵢ_{₁}_{, . . . , i}_{ₘ} with iₚ≦Iₚ, i_{q}≦I_{q} and iᵣ=Iᵣ+1 (r∉{p,q}) is equal to the second-order inter-group correlation βᵢ_{ₚ}_{,i}_{_{q}}^{(p,q)}; and wᵢ_{₁}_{, . . . , i}_{ₘ} related to all the m features with indexes iₚ≦Iₚ is equal to the m-th order inter-group correlation βᵢ_{₁}_{, . . . , i}_{ₘ}. For a model parameter wᵢ_{₁}_{, . . . , i}_{ₘ} related to some features with indexes iₚ≦Iₚ from some but not all of the m groups, the dummy features with indexes iₚ=Iₚ+1 in other groups may be involved.

The number of model parameters to be estimated wᵢ_{₁}_{, . . . , i}_{ₘ} in Equation (2) is Πₚ₌₁^{m}(Iₚ+1). Although the number of parameters to be estimated is increased compared to Equation (1), it may be more convenient to learn the model parameters since they are all extended to the same subspace. With the structure of the model determined in Equation (2), a variety of training methods, no matter currently known or developed in the future, may be utilized to train the model parameters. In some implementations, the model parameters in Equation (2) may be determined in a similar way to the model parameters in Equation (1), but will cost less time and computation resources.

The implementations where all the model parameters are extended to the subspace of correlations in the highest order are described above in detail. For the implementations where the model parameters in two or more orders may be extended to the same subspace related to the highest order among those orders, while model parameters in other orders may not be extended or may be extended to other subspaces, a similar way may be applied for the respective subspaces. For example, the second-order correlations and the third-order correlations may be selected to be extended to the same subspace, and then the dimension of the second-order correlations may be extended to a higher three-dimensional subspace of the third-order correlations. The correlations in orders higher than the second order may remain the same or may be extended to another subspace, for example, the m-th dimensional subspace. In these implementations, the model to be trained may also be simplified and the training complexity may be reduced.

In some other implementations, a factorization method may be utilized to determine the model parameters with the same dimensions, for example, in the same subspace. For the case where all the model parameters are extended to the same m-dimensional subspace, each of the Pt model parameters wᵢ_{₁}_{, . . . , i}_{ₘ} may be represented as a m-th order tensor

$$= \{ \} ∈ {( {I}_{1} + 1 ) \times … \times ( {I}_{2} + 1 )}^{}$$

This tensor may be collectively factorized into a plurality of factors. The factors may then be determined based on the training dataset and the determined factors may be regarded as the model parameter.

Various factorization methods, no matter currently known or developed in the future, may be utilized to factorize the model parameter [symbol] . An example factorization method includes a Candecomp-Parafac (CP) factorization. In other examples, other factorization methods may be used. It is supposed that the number of the factors is k, and the factorization of the tensor

$$= \{ \} ∈ {ℝ}^{( {I}_{1} + 1 ) \times … \times ( {I}_{2} + 1 )}$$

may be represented as follows:

Ω=Cx₁A⁽¹⁾x₂ . . . xₘA^{(m)} (3)

where A^{(p)}∈ [symbol] ( [symbol] ) is a matrix having its iₚ-th row aᵢ_{ₚ}^{(p)}^{^{T}}=(aᵢ_{ₚ}_{,1}^{(p)}, . . . , aᵢ_{ₚ}_{,k}^{(p)}), and C∈ [symbol] [symbol] is the identity tensor. It would be appreciated that the number of the factors in the factorization may be predetermined as any integer value greater than one.

The definition of a mode-l product ΞxₗM of a tensor Ξ and a matrix M is presented as follows:

$${( Ξ {\times }_{l} M )}_{{i}_{1} , … , {i}_{l - 1} , j , {i}_{l + 1} , … , {i}_{m}} = {\sum }_{{i}_{l = 1}}^{{I}_{l}} {x}_{{i}_{1} , … , {i}_{m}} {m}_{j , {i}_{l}} \qquad ( 4 )$$

where [symbol] ∈ [symbol] ^{I}^{₁}^{x . . . xI}^{ₘ}, M∈ [symbol] [symbol] with I′ₗ rows and Iₗ columns, xᵢ_{₁}_{, . . . , i}_{ₘ} represents an element in the tensor Ξ, and m_{j,i}_{ₗ} represents an element in the matrix M. It would be appreciated that the mode-l product of a tensor and a matrix is known by those skilled in the art.

Based on the factorization of all the extended model parameters

$$Ω = \{ \} ∈ {ℝ}^{( {I}_{1} + 1 ) \times … \times ( {I}_{2} + 1 )} ,$$

Equation (3) may be rewritten as follows:

$$\hat{y} = {\sum }_{{i}_{1} = 1}^{{I}_{1} + 1} … {\sum }_{{i}_{m} = 1}^{{I}_{m} + 1} ( {\prod }_{p = 1}^{m} {z}_{{i}_{p}}^{( p )} ) ( {\sum }_{f = 1}^{k} {\prod }_{p = 1}^{m} {a}_{{i}_{p} , f}^{( p )} ) \qquad ( 5 )$$

where zᵢ_{ₚ}^{(p)} represents a feature from the p-th group z^{(p)}^{^{T}}=(x^{(p)}^{^{T}},1)∈□^{I}^{ₚ}⁺¹ with a dummy feature of 1 included therein; and aᵢ_{ₚ}_{,f}^{(p)} represents a factor to be determined and a model parameter [symbol] =Σ_{f=1}^{k}Πₚ₌₁^{m}aᵢ_{ₚ}_{,f}^{(p)}. In the model of Equation (5), A^{(p)}∈ [symbol] [symbol] with p=1, . . . , m has its iₚ-th row represented by aᵢ_{ₚ}^{(p)}^{^{T}}=(aᵢ_{ₚ}_{,1}^{(p)}, . . . , aᵢ_{ₚ}_{,k}^{(p)}) that describes k factors related to the iₚ-th feature in the p-th group.

In some implementations, the model parameter of bias value may be a collection of bias from the k factors. If it is supposed that the dummy features in the m groups having indexes iₚ=Iₚ+1, the last row of A^{(p)}, for example, a_{I}_{ₚ}₊₁^{(p)T}, represents bias factors for the p-th group and it is associated the dummy feature z_{I}_{ₚ}₊₁^{(p)}=1 in each of the groups. Then the bias value for the model may be represented as follows:

$${w}_{{I}_{1} + 1 , … , {I}_{m} + 1} {\sum }_{f = 1}^{k} {\prod }_{p = 1}^{m} {a}_{{I}_{p} + 1 , f}^{( p )} \qquad ( 6 )$$

Other model parameters in Equation (2) may be similarly determined, for example, based on [symbol] =Σ_{f=1}^{k}Πₚ₌₁^{m}aᵢ_{ₚ}_{,f}^{(p)}.

It can be seen from Equation (5) that the number of parameters to be estimated is reduced from Πₚ₌₁^{m}(Iₚ+1) in Equation (2) to kΣₚ₌₁^{m} (Iₚ+1)=k(m+d), thereby significantly saving the time and computation resources. In addition to the decreasing of the time and computation complexity, using the factorization to the extended model parameters in the same subspace may also benefit for the cases where the training dataset has sparse features. In many cases, not all the features having a meaningful value can be extracted from a context of a historical input. For example, for a specific historical input in the ad targeting, it may be impossible to obtain a value for the features of the age of the user. Generally, a constant value (for example, zero) may be assigned for those features whose meaningful values are not determined. Training dataset having many features with the value of zero may be regarded as sparse training dataset.

The sparsity of the training dataset may not be desirable for the determination of the model parameters, especially for the determination of model parameters in high orders. For example, in order to determine the second-order inter-group correlation βᵢ_{ₚ}_{,i}_{_{q}}^{(p,q)} of features xᵢ_{ₚ}^{(p)} and xᵢ_{_{q}}^{(q)} from groups iₚ and i_{q}, only historical inputs whose features xᵢ_{ₚ}^{(p)}≠0 and xᵢ_{_{q}}^{(q)}≠0 can be used to learn the correlation βᵢ_{ₚ}_{,i}_{_{q}}^{(p,q)}. By using the factorization, the sparsity of the training dataset may have a less impact on the determination of the model parameters. As shown in Equation (5), this is because the factor aᵢ_{ₚ}^{(p)} can be learned from any historical inputs whose feature xᵢ_{ₚ}^{(p)}≠0 and the factor aᵢ_{_{q}}^{(q)} can be learned from any inputs whose feature xᵢ_{_{q}}^{(q)}≠0, which therefore allows correlations in high orders can also be determined even using the sparse training dataset. For example, a second-order inter-group correlation βᵢ_{ₚ}_{,i}_{_{q}}^{(p,q)}, which is represented as [symbol] with iₚ≦Iₚ, i_{q}≦I_{q}, and iᵣ=Iᵣ+1 (r∉{p,q}) after extending, may be learned from historical inputs whose features xᵢ_{ₚ}^{(p)}≠0 or xᵢ_{_{q}}^{(q)}≠0 based on the factor aᵢ_{ₚ}^{(p)} or the factor aᵢ_{_{q}}^{(q)} in the model of Equation (5).

On the other hand, since the model parameters are all extended into the same subspace, it is helpful for consistent representation of the features in all orders as the bias value for the model, the weights for the features, and the correlations in different orders are learned dependently from all the features of the historical inputs and the corresponding outputs. For example, all features of an historical input are used to learn a factor aᵢ_{ₚ}^{(p)}. Then a combination of the factor aᵢ_{ₚ}^{(p)} and the bias factors from other (m−1) groups a_{I}_{₁}₊₁⁽¹⁾, . . . , a_{I}_{_{p−1}}₊₁^{(p-1)}, a_{I}_{ₚ₊₁}₊₁^{(p+1)}, . . . , a_{I}_{ₘ}₊₁^{(m)} may be determined as a weight [symbol] for a feature xᵢ_{ₚ}^{(p)} (where only iₚ≦Iₚ, i_{q}=I_{q}+1, and q≠p). The second-order inter-group correlation [symbol] of features xᵢ_{ₚ}^{(p)} and xᵢ_{_{q}}^{(q)} (where iₚ≦Iₚ, i_{q}≦I_{q}, iᵣ=Iᵣ+1 and r∉{p,q}) may also be determined by combing aᵢ_{ₚ}^{(p)}, aᵢ_{_{q}}^{(q)}, and the bias factors from other (m−2) groups. Similarly, aᵢ_{ₚ}^{(p)} may be used to determine inter-group correlations in other orders as well as the bias value for the model.

It would be appreciated that although the factorization of the model parameters extending to the m-dimensional subspace is described above, the factorization may be similarly applied in the cases where some of the model parameters are extended to one subspace. It would also be appreciated that, with the structure of the model determined in Equation (5), a variety of training methods, no matter currently known or developed in the future, may be utilized to learn the model parameters. In some implementations, the model parameters in Equation (5) may be determined in a similar way to the model parameters in Equation (1) or (2).

In some cases, when there are a large number of groups (views) available and some of the groups may not be correlated with each other, inter-group correlations of features from those groups may be meaningless for the model or inter-group correlations of feature in high orders may not be interpretable. In these cases, all the groups may be divided into a plurality of super-groups. Each of the super-groups may include at least one of the groups. For example, two or more of the groups may be used to generate a super-group, and the other groups may be regarded as another super-group. It would be appreciated that the number of the generated super-groups is not limited herein. In some other implementations, the super-groups may be overlapped. For example, a group of the groups may be used to generate two or more super-groups.

By dividing the super-groups, inter-group correlations of features from different groups included in different super-groups may be excluded. Only the inter-group correlations of features from different groups within the same super-group are considered. In some implementations, for each of the super-groups, a machine learning model such as a model represented in Equation (1), (2), or (5) may be determined. The determined models may be combined to obtain the final model for the use case related to the training dataset. In the cases where a super-group includes only one group of features, the model determined for this super-group may be constructed as a combination of a bias value for the model and weights for the features in the super-group.

The trained model, for example, the determined association indicating the model parameters, may be stored in a storage device for future use. In some implementations, the model may be used to predict outputs for further input events. For example, a model constructed for the ad targeting may be used to predict if an ad presented to a specific user in response to receiving an input query from the user will lead to a click by the user. It would help to determine which ad should be presented to the user. In some implementations, the model may be provided, for example, to the model executing system 120 from the model building system 110 in FIG. 1 and may be stored by the model executing system 120 for use.

In some implementations, in response receiving an input from the user, the feature extractor 124 of the system 120 may extract features from a context of the input and assign the features into a plurality of groups in a similar way to the feature abstraction and assignment during the model training, for example, in the feature extractor 114. The feature extractor 124 may receive from the feature extractor 114 an indication of a rule of the feature assignment. The indication may indicate which features are assigned into which groups and whether one or more features are repeated in some of the groups. The indication may also indicate whether dummy features are to be added into the group(s). The plurality of groups may then be provided to the executing unit 126. The executing unit 126 may generate an output based on the groups of features according to the association indicating the model parameters.

In ad targeting, in response to receiving a new input query from a user, a context of the input query may be used to determine a plurality of features. The types of the features may be similar to those extracted from the historical inputs during the model training, including, for example, the age of the user, and the gender of the user, query words, the address of an ad to be presented in response to the query, the location of the ad, and the matched type of the ad. If the features of the training dataset are assigned into three groups in the model building process, the features of this new input may also be assigned into three groups based on the same assignment rule. Based on the groups of features, an output indicating whether the ad will be clicked may be determined according to the association determined for the trained model.

It would be appreciated that in the above description, the use case of ad targeting is given merely for the purpose illustration. The model building process may be applied to any other use cases (such as movie rating, recommendation of services or products for users, and the like) and train a multi-view machine learning model based on the training dataset in the use cases. The trained model may then be used back for make predictions for those use cases.

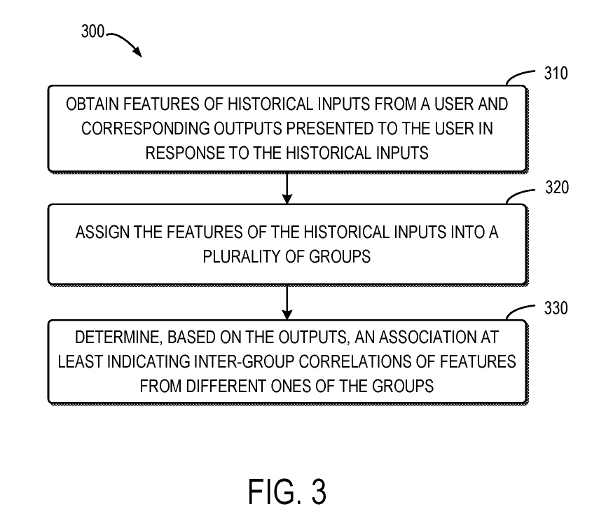

FIG. 3 shows a flowchart of a method of machine learning in accordance with one implementation of the subject matter described herein. In step 310, features of historical inputs from a user and corresponding outputs presented to the user in response to the historical inputs are obtained. The features are determined based on contexts of the historical inputs, the contexts indicating information related to the user. In step 320, the features of the historical inputs are assigned into a plurality of groups. In step 330, an association is determined based on the outputs, the association at least indicating inter-group correlations of features from different ones of the groups.

In some implementations, a first inter-group correlation of features selected from a first number of the groups and a second inter-group correlation of features from a second number of the groups, the second number being different from the first number may be determined.

In some implementations, the first number is less than the second number. In these implementations, a dimension of the first inter-group correlation may be extended by adding dummy features to the second number of the groups according to the second number.

In some implementations, the extended first inter-group correlation and the second inter-group correlation may be factorized to obtain a plurality of factors, and the plurality of factors may be determined based on the outputs as the first and second inter-group correlations.

In some implementations, the association may further indicate a factor related to at least one of weights for the features or a bias value. In these implementations, a dimension of the factor may be extended by adding dummy features to the second number of the groups according to the second number.

In some implementations, a super-group may be generated based on a first group and a second group from the plurality of groups. Then the inter-group correlation of features within the super-group may be determined.

In some implementations, a further super-group may be determined based on the first group and a third group from the plurality of groups. Then the inter-group correlation of features within the further super-group may be determined.

In some implementations, a first feature of the features may be assigned into at least two of the groups.

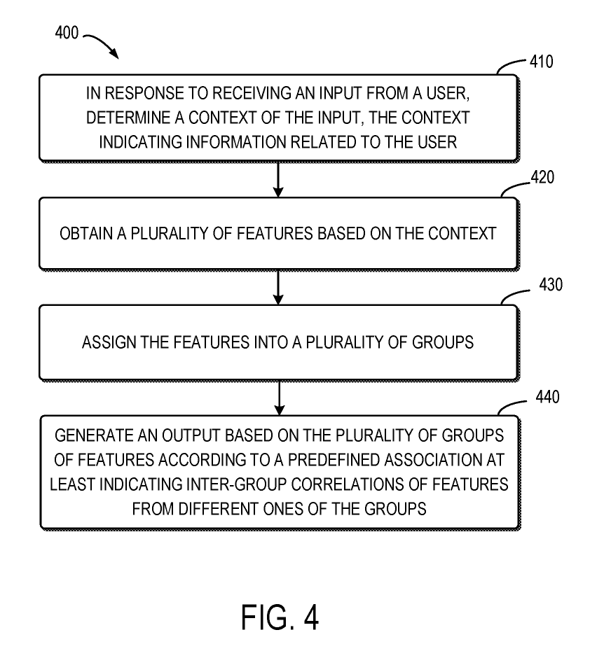

FIG. 4 shows a flowchart of a method of machine learning in accordance with another implementation of the subject matter described herein. In step 410, in response to receiving an input from a user, a context of the input is determined. The context indicates information related to the user. A plurality of features based on the context is obtained in step 420, and the features are assigned into a plurality of groups in step 430. In step 440, an output is generated based on the plurality of groups of features according to a predefined association at least indicating inter-group correlations of features from different ones of the groups.

In some implementations, the association indicates a first inter-group correlation of features selected from a first number of the groups and a second inter-group correlation of features from a second number of the groups, and the first number is less than the second number. In these implementations, the groups may be modified by adding dummy features to the second number of the groups based on the second number. The output may be generated based on the modified groups according to the association.

In some implementations, the association further indicates a factor related to at least one of weights for the features or a bias value.

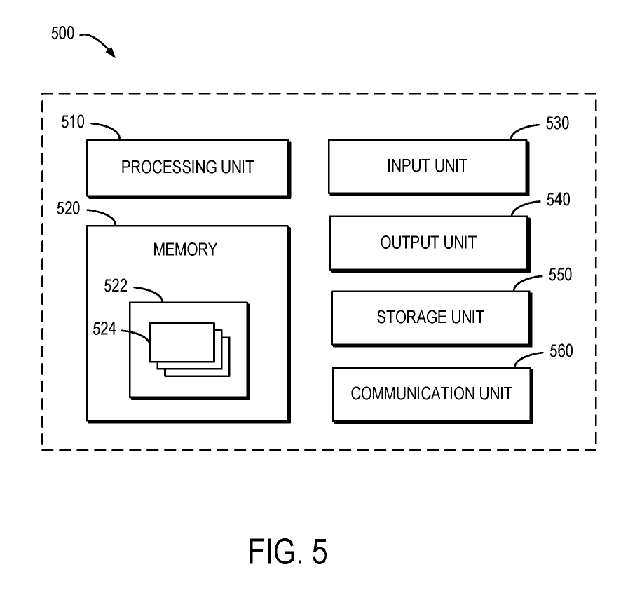

FIG. 5 shows a block diagram of an example computing system/server 500 in which one or more implementations of the subject matter described herein may be implemented. The model building system 110, the model executing system 120, or both of them may be implemented by the computing system/server 500. The computing system/server 500 as shown in FIG. 5 is only an example, which should not be constructed as any limitation to the function and scope of use of the implementations of the subject matter described herein.

As shown in FIG. 5, the computing system/server 500 is in a form of a general-purpose computing device. Components of the computing system/server 500 may include, but are not limited to, one or more processors or processing units 510, a memory 520, one or more input devices 530, one or more output devices 540, storage 550, and one or more communication units 560. The processing unit 510 may be a real or a virtual processor and is capable of performing various processes in accordance with a program stored in the memory 520. In a multi-processing system, multiple processing units execute computer-executable instructions to increase processing power.

The computing system/server 500 typically includes a variety of machine readable medium. Such medium may be any available medium that is accessible by the computing system/server 500, including volatile and non-volatile medium, removable and non-removable medium. The memory 520 may be volatile memory (e.g., registers, cache, a random-access memory (RAM)), non-volatile memory (e.g., a read only memory (ROM), an electrically erasable programmable read only memory (EEPROM), a flash memory), or some combination thereof. The storage 550 may be removable or non-removable, and may include machine readable medium such as flash drives, magnetic disks or any other medium which can be used to store information and which can be accessed within the computing system/server 500.

The computing system/server 500 may further include other removable/non-removable, volatile/non-volatile computing system storage medium. Although not shown in FIG. 5, a disk driver for reading from or writing to a removable, non-volatile disk (e.g., a “floppy disk”), and an optical disk driver for reading from or writing to a removable, non-volatile optical disk can be provided. In these cases, each driver can be connected to the bus 18 by one or more data medium interfaces. The memory 520 may include at least one program product having a set (e.g., at least one) of program modules that are configured to carry out the functions of various implementations of the subject matter described herein.

A program/utility tool 522 having a set (at least one) of the program modules 524 may be stored in, for example, the memory 520. Such program modules 524 include, but are not limited to, an operating system, one or more applications, other program modules, and program data. Each or a certain combination of these examples may include an implementation of a networking environment. The program modules 524 generally carry out the functions and/or methodologies of implementations of the subject matter described herein, for example, the method 300 and/or the method 400.

The input unit(s) 530 may be one or more of various different input devices. For example, the input unit(s) 530 may include a user device such as a mouse, keyboard, trackball, etc. The input unit(s) 530 may implement one or more natural user interface techniques, such as speech recognition or touch and stylus recognition. As other examples, the input unit(s) 530 may include a scanning device, a network adapter, or another device that provides input to the computing system/server 500. The output unit(s) 540 may be a display, printer, speaker, network adapter, or another device that provides output from the computing system/server 500. The input unit(s) 530 and output unit(s) 540 may be incorporated in a single system or device, such as a touch screen or a virtual reality system.

The communication unit(s) 560 enables communication over communication medium to another computing entity. Additionally, functionality of the components of the computing system/server 500 may be implemented in a single computing machine or in multiple computing machines that are able to communicate over communication connections. Thus, the computing system/server 500 may operate in a networked environment using logical connections to one or more other servers, network personal computers (PCs), or another common network node. By way of example, and not limitation, communication media include wired or wireless networking techniques.

The computing system/server 500 may also communicate, as required, with one or more external devices (not shown) such as a storage device, a display device, and the like, one or more devices that enable a user to interact with the computing system/server 500, and/or any device (e.g., network card, a modem, etc.) that enables the computing system/server 500 to communicate with one or more other computing devices. Such communication may be performed via an input/output (I/O) interface(s) (not shown).

The functionally described herein can be performed, at least in part, by one or more hardware logic components. For example, and without limitation, illustrative types of hardware logic components that can be used include Field-Programmable Gate Arrays (FPGAs), Application-specific Integrated Circuits (ASICs), Application-specific Standard Products (ASSPs), System-on-a-chip systems (SOCs), Complex Programmable Logic Devices (CPLDs), and the like.

Program code for carrying out methods of the subject matter described herein may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of this disclosure, a machine readable medium may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the subject matter described herein, but rather as descriptions of features that may be specific to particular implementations. Certain features that are described in the context of separate implementations may also be implemented in combination in a single implementation. Conversely, various features that are described in the context of a single implementation may also be implemented in multiple implementations separately or in any suitable sub-combination.

Some implementations of the subject matter described herein are listed below.

In some implementations, a device is provided. The device comprises a processing unit and a memory coupled to the processing unit and storing instructions thereon, the instructions, when executed by the processing unit, performing acts including: obtaining features of historical inputs from a user and corresponding outputs presented to the user in response to the historical inputs, the features being determined based on contexts of the historical inputs, the contexts indicating information related to the user; assigning the features of the historical inputs into a plurality of groups; and determining, based on the outputs, an association at least indicating inter-group correlations of features from different ones of the groups.

In some implementations, the determining comprises determining a first inter-group correlation of features selected from a first number of the groups and a second inter-group correlation of features from a second number of the groups, the second number being different from the first number.

In some implementations, the first number is less than the second number, and the acts further include: extending a dimension of the first inter-group correlation by adding dummy features to the second number of the groups according to the second number.

In some implementations, the determining comprises factorizing the extended first inter-group correlation and the second inter-group correlation to obtain a plurality of factors, and determining, based on the outputs, the plurality of factors as the first and second inter-group correlations.

In some implementations, the association further indicates a factor related to at least one of weights for the features or a bias, and the acts further include extending a dimension of the factor by adding dummy features to the second number of the groups according to the second number.

In some implementations, determining the association comprises generating a super-group based on a first group and a second group from the plurality of groups and determining the inter-group correlation of features within the super-group.

In some implementations, determining the association further comprises generating a further super-group based on the first group and a third group from the plurality of groups, and determining the inter-group correlation of features within the further super-group.

In some implementations, the assigning comprises assigning a first feature of the features into at least two of the groups.

In some implementations, the association is stored in a storage device.

In some implementations, a device is provided. The device comprises a processing unit and a memory coupled to the processing unit and storing instructions thereon, the instructions, when executed by the processing unit, performing acts including: in response to receiving an input from a user, determining a context of the input, the context indicating information related to the user; obtaining a plurality of features based on the context; assigning the features into a plurality of groups; and generating an output based on the plurality of groups of features according to a predefined association at least indicating inter-group correlations of features from different ones of the groups.

In some implementations, the association indicates a first inter-group correlation of features selected from a first number of the groups and a second inter-group correlation of features from a second number of the groups, the first number is less than the second number. The generating comprises modifying the plurality of groups by adding dummy features to the second number of the groups based on the second number, and generating the output based on the modified groups according to the association.

In some implementations, the association further indicates a factor related to at least one of weights for the features or a bias value.

In some implementations, a computer-implemented method is provided. The method comprises: obtaining features of historical inputs from a user and corresponding outputs presented to the user in response to the historical inputs, the features being determined based on contexts of the historical inputs, the contexts indicating information related to the user; assigning the features of the historical inputs into a plurality of groups; and determining, based on the outputs, an association at least indicating inter-group correlations of features from different ones of the groups.

In some implementations, the determining comprises determining a first inter-group correlation of features selected from a first number of the groups and a second inter-group correlation of features from a second number of the groups, the second number being different from the first number.

In some implementations, the first number is less than the second number, and the acts further include extending a dimension of the first inter-group correlation by adding dummy features to the second number of the groups according to the second number.

In some implementations, the determining comprises factorizing the extended first inter-group correlation and the second inter-group correlation to obtain a plurality of factors, and determining, based on the outputs, the plurality of factors as the first and second inter-group correlations.

In some implementations, the association further indicates a factor related to at least one of weights for the features or a bias value, and the method further comprises extending a dimension of the factor by adding dummy features to the second number of the groups according to the second number.

In some implementations, determining the association comprises generating a super-group based on a first group and a second group from the plurality of groups and determining the inter-group correlation of features within the super-group.

In some implementations, determining the association further comprises generating a further super-group based on the first group and a third group from the plurality of groups, and determining the inter-group correlation of features within the further super-group.

In some implementations, the assigning comprises assigning a first feature of the features into at least two of the groups.

In some implementations, a computer-implemented method is provided. The method comprises: in response to receiving an input from a user, determining a context of the input, the context indicating information related to the user; obtaining a plurality of features based on the context; assigning the features into a plurality of groups; and generating an output based on the plurality of groups of features according to a predefined association at least indicating inter-group correlations of features from different ones of the groups.

In some implementations, the association indicates a first inter-group correlation of features selected from a first number of the groups and a second inter-group correlation of features from a second number of the groups, the first number is less than the second number. The generating comprises modifying the plurality of groups by adding dummy features to the second number of the groups based on the second number, and generating the output based on the modified groups according to the association.

In some implementations, the association further indicates a factor related to at least one of weights for the features or a bias value.

Although the subject matter has been described in language specific to structural features and/or methodological acts, it is to be understood that the subject matter specified in the appended claims is not necessarily limited to the specific features or acts described above. Rather, the specific features and acts described above are disclosed as example forms of implementing the claims.

I/We claim:

1. A device comprising:
a processing unit;
a memory coupled to the processing unit and storing instructions thereon, the instructions, when executed by the processing unit, performing acts including:
obtaining features of historical inputs from a user and corresponding outputs presented to the user in response to the historical inputs, the features being determined based on contexts of the historical inputs, the contexts indicating information related to the user;
assigning the features of the historical inputs into a plurality of groups; and
determining, based on the outputs, an association at least indicating inter-group correlations of features from different ones of the groups.

2. The device of claim 1, wherein the determining comprises:
determining a first inter-group correlation of features selected from a first number of the groups and a second inter-group correlation of features from a second number of the groups, the second number being different from the first number.

3. The device of claim 2, wherein the first number is less than the second number, and the acts further include:
extending a dimension of the first inter-group correlation by adding dummy features to the second number of the groups according to the second number.

4. The device of claim 3, wherein the determining comprises:
factorizing the extended first inter-group correlation and the second inter-group correlation to obtain a plurality of factors; and
determining, based on the outputs, the plurality of factors as the first and second inter-group correlations.

5. The device of claim 2, wherein the association further indicates a factor related to at least one of a bias value or weights for the features, and the acts further include:
extending a dimension of the factor by adding dummy features to the second number of the groups according to the second number.

6. The device of claim 1, wherein determining the association comprises:
generating a super-group based on a first group and a second group from the plurality of groups; and
determining the inter-group correlation of features within the super-group.

7. The device of claim 6, wherein determining the association further comprises:
generating a further super-group based on the first group and a third group from the plurality of groups; and
determining the inter-group correlation of features within the further super-group.

8. The device of claim 1, wherein the assigning comprises:
assigning a first feature of the features into at least two of the groups.

9. The device of claim 1, wherein the determined association is stored in a storage device.

10. A device comprising:
a processing unit;
a memory coupled to the processing unit and storing instructions thereon, the instructions, when executed by the processing unit, performing acts including:
in response to receiving an input from a user, determining a context of the input, the context indicating information related to the user;
obtaining a plurality of features based on the context;
assigning the features into a plurality of groups; and
generating an output based on the plurality of groups of features according to a predefined association at least indicating inter-group correlations of features from different ones of the groups.

11. The device of claim 10, wherein the association indicates a first inter-group correlation of features selected from a first number of the groups and a second inter-group correlation of features from a second number of the groups, the first number is less than the second number; and
wherein the generating comprises:
modifying the plurality of groups by adding dummy features to the second number of the groups based on the second number; and
generating the output based on the modified groups according to the association.

12. The device of claim 10, wherein the association further indicates a factor related to at least one of a bias value or weights for the features.

13. A computer-implemented method comprising:
obtaining features of historical inputs from a user and corresponding outputs presented to the user in response to the historical inputs, the features being determined based on contexts of the historical inputs, the contexts indicating information related to the user;
assigning the features of the historical inputs into a plurality of groups; and
determining, based on the outputs, an association at least indicating inter-group correlations of features from different ones of the groups.

14. The method of claim 13, wherein the determining comprises:
determining a first inter-group correlation of features selected from a first number of the groups and a second inter-group correlation of features from a second number of the groups, the second number being different from the first number.

15. The method of claim 14, wherein the first number is less than the second number, and the acts further include:
extending a dimension of the first inter-group correlation by adding dummy features to the second number of the groups according to the second number.

16. The method of claim 15, wherein the determining comprises:
factorizing the extended first inter-group correlation and the second inter-group correlation to obtain a plurality of factors; and
determining, based on the outputs, the plurality of factors as the first and second inter-group correlations.

17. The method of claim 14, wherein the association further indicates a factor related to at least one of weights for the features or a bias value, and the acts further include:
extending a dimension of the factor by adding dummy features to the second number of the groups according to the second number.

18. The method of claim 13, wherein determining the association comprises:
generating a super-group based on a first group and a second group from the plurality of groups; and
determining the inter-group correlation of features within the super-group.

19. The method of claim 18, wherein determining the association further comprises:
generating a further super-group based on the first group and a third group from the plurality of groups; and
determining the inter-group correlation of features within the further super-group.

20. The method of claim 13, wherein the assigning comprises:
assigning a first feature of the features into at least two of the groups.
